(19) United States
(12) Patent Application Publication
(10) Pub. No.: US 2005/0239534 A1
(43) Pub. Date: Oct. 27, 2005

(54) Card dispensing machine

(76) Inventors: Dennis L. Carstens, Columbus, NE (US); Kent E. Carstens, Columbus, NE (US); Grant F. Kowell, Canton, OH (US)

Correspondence Address: CARSTENS YEE & CAHOON, LLP, P O BOX 802334, DALLAS, TX, 75380, US

(21) Appl. No.: 11/114,839

(22) Filed: Apr. 26, 2005

Related U.S. Application Data
(63) Continuation-in-part of application No. 10/919,427, filed on Aug. 16, 2004.
(60) Provisional application No. 60/565,662, filed on Apr. 27, 2004.

(51) Int. Cl. A63F 13/00

(52) U.S. Cl. 463/16

(57) ABSTRACT

The present invention is a free-standing vending machine that accepts currency and dispenses cards at certain values. The cards may be product coupons or trading cards. The machine may have multiple columns of cards, each column having cards with different values and offering different promotions. The cards are promoted by a sweepstakes game. A control board in the vending machine contains the rules of the sweepstakes game and determines whether a card is a winner or loser as each card is drawn from its respective column. A printer prints the winner/loser information and any prize amount on the cards as each card is drawn from its column. The latest card drawn from each column is displayed such that a customer can see whether the card is a sweepstakes winner or loser before purchasing the card.

### CROSS-REFERENCE TO RELATED APPLICATIONS

This application claims the benefit of and priority to U.S. patent application Ser. No. 10/919,427 filed Aug. 16, 2004 and U.S. Provisional Patent Application No. 60/565,662 filed Apr. 27, 2004 the technical disclosures of which are hereby incorporated herein by reference.

### BACKGROUND OF THE INVENTION

1. Technical Field

The present invention relates generally to a vending machine and more specifically to a vending machine that dispenses cards which are promoted by a sweepstakes game.

2. Description of Related Art

Vending machines and kiosks are becoming an increasingly popular means for distributing items such as tickets, coupons, trading cards, and lottery cards. These machines are often deployed within retail locations as an incentive to purchase particular lines of items or services. As an additional inducement to increase purchases, the cards distributed by the vending machines may also be associated with a sweepstakes game, in which prizes are awarded in addition to the specific value of the coupons or tickets purchased by the customer.

A variety of lottery and sweepstakes games exist in the art. One type of lottery game allows the player to pick the numbers to be played in the game. Another type of lottery game only allows the player to pick a card or game piece which includes hidden numbers or prizes that the player cannot see until after purchasing the game piece.

However, depending how they are structured, some sweepstakes games may be classified as illegal gambling in some jurisdictions. Therefore, it would be desirable to have a method for promoting the sale of coupons or trading cards through a sweepstakes game that does not violate the legal restrictions on gambling in particular jurisdictions.

### SUMMARY OF THE INVENTION

The present invention is a free-standing vending machine that accepts currency and dispenses cards at certain values. The cards may be product coupons, trading cards, or similar card products. The machine has multiple columns of cards, each column having cards with different values and offering different promotions. The machine has a graphic presentation showing the instructions of operation, the price of the cards, and a certain amount of advertising.

The cards are also part of a sweepstakes game. An offsite server contains the rules of the sweepstakes game and operates the game through a control board in the vending machine. The server determines whether a card is a winner or loser as each card is drawn from its respective column. A printer prints the winner/loser information and any prize amount on the cards as each card is drawn from its column. The latest card drawn from each column is displayed such that a customer can see whether the card is a sweepstakes winner or loser before purchasing the card.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A shows the card dispensing machine cabinet in accordance with the present invention;

FIG. 1B shows a side cross section view of the card dispenser;

FIG. 2A shows a perspective view of an alternate embodiment of the card dispenser in accordance with the present invention;

FIG. 2B shows a side, cutaway view of the alternate embodiment of the card dispenser;

FIG. 2C shows a perspective view of the alternate card dispenser with the front panel opened;

FIG. 3 is a flowchart illustrating the operations of the card dispensing machine; and

FIG. 4 shows an example of a coupon sweepstakes card in accordance with the present invention.

### DETAILED DESCRIPTION OF THE INVENTION

The present invention is a free-standing vending machine that accepts currency and dispenses cards at certain values. The machine has multiple columns of cards, each column having cards with different values and offering different promotions. The machine has a graphic presentation showing the instructions of operation, the price of the cards, and a certain amount of advertising.

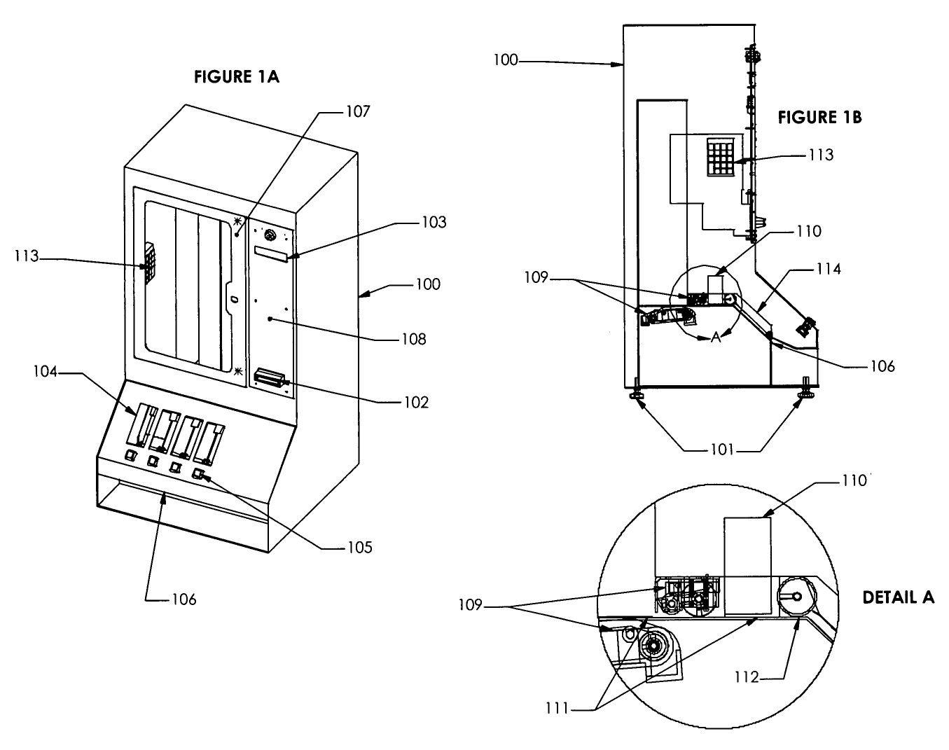

FIG. 1A shows the card dispensing machine cabinet in accordance with the present invention. The cabinet 100 has a floor mounting and leveling features 101 (shown clearly in FIG. 1B). A bill acceptor 102 is installed within the cabinet such that a customer can insert cash into the machine. A coin slot may also be installed but is not included in the present example. A liquid crystal display (LCD) 103 on the cabinet provides users with currency credit information (based on deposited money), inventory status, malfunctions, etc. The bill acceptor 102 identifies the denomination of the currency, and sends this information to a control board (not pictured), which displays the currency credit on the LCD 103.

Each column of cards has a display window 104 showing the card currently held in the final dispense position and a lighted push button 105 for selecting that column. Purchased cards are fed to the customer through dispensing slots 106 for each column (shown more clearly in FIG. 1B).

The cabinet contains security features such that the cash and the cards are located in separately locked compartments. There are two locked doors, one for the product 107 and the other for the cash 108.

FIG. 1B shows a side cross section view of the card dispenser. The card dispensing mechanism 109 removes the bottom card from one of the columns and delivers the card to a printer 110. The printer 110 prints the winning or losing information on the sweepstakes tab portion of the card, and the card is then moved to the feeding mechanism 112 that pushes the card forward to the final dispense position 114 under the display window 104. The next card 111 is then moved from the bottom of the stack to the printer 110.

Multiple stacks of cards are placed into the machine and positioned properly face up with one specific edge leading in the proper column. Each column is priced to correspond with the product being sold.

In one embodiment of the present invention, one of the columns (e.g., the fourth) dispenses a gift card. After the customer has purchased a card from one of the other three columns, the customer may obtain change for the balance of his credits by selecting the fourth column, which is loaded with a gift card that has the value of the change balance printed onto it. This option eliminates the concern that may be raised by regulators that once the customer inserts money into the machine and purchases one coupon/game card, the customer is then forced to “gamble” with his change.

This pricing is electronically selected and entered into the control board by means of a keypad 113. The price is also displayed on the lighted push button on the machine by inserting a label under the top cover of the push button cap.

The person loading the machine with cards makes certain that there is one card properly oriented and placed into the final dispense position 114 of each column. This card (and its winner information) is visible to the customer through the display window 104.

The keypad 113 allows input and programming of the machine's control board (not pictured). The keypad allows personnel at the location to communicate with the control board, including entering price information, product serial number, activation code, date and time. It also is used to get outputs from the control board via the LCD 103, e.g., cards sold since the machine was last set, cards sold this week, cash receipts, etc. This information can also be sent to a remote location via a modem or other communication link.

Those of ordinary skill in the art will appreciate that the dispensing machine depicted in FIGS. 1A and 1B may vary. The depicted example is not meant to imply design limitations with respect to the present invention.

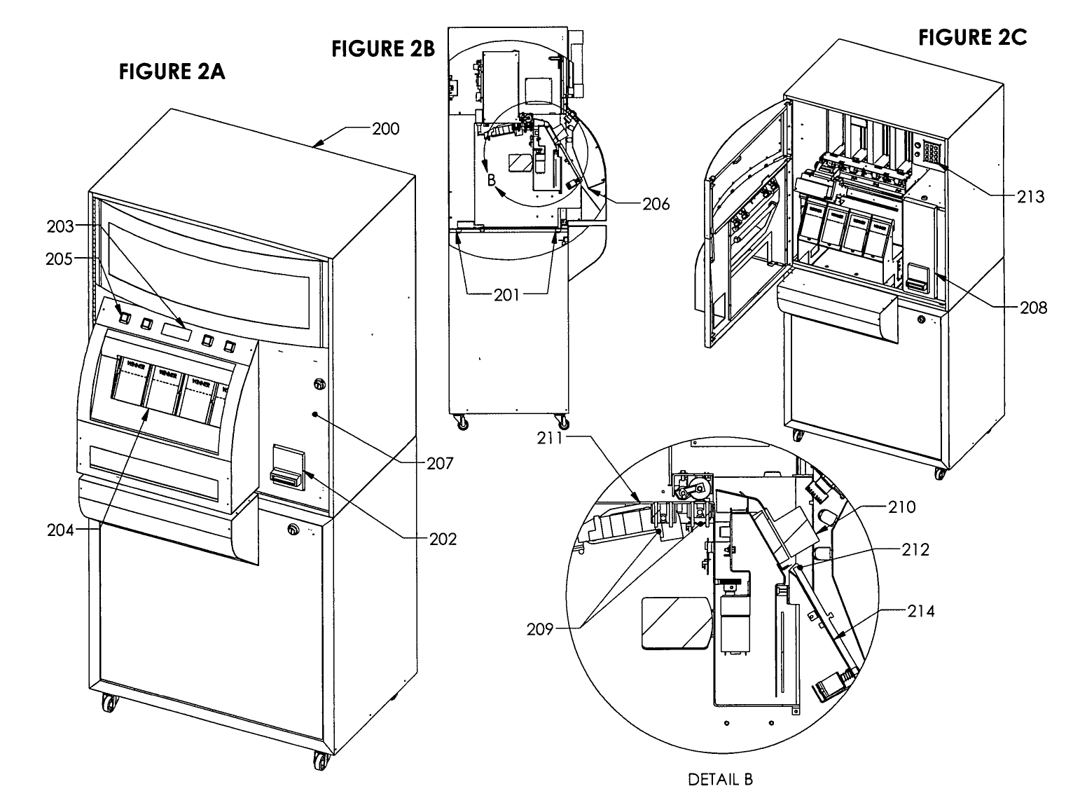

FIGS. 2A, 2B and 2C depict an alternate embodiment of the card dispenser in accordance with the present invention. Like the model described above, the cabinet 200 has a leveling feature 201 (shown clearly in FIG. 2B). A bill acceptor 202 is installed within the cabinet such that a customer can insert cash into the machine, and a liquid crystal display (LCD) 203 provides users with currency credit information, inventory status, malfunctions, etc. The bill acceptor 202 identifies the denomination of the currency, and sends this information to a control board (not pictured), which displays the currency credit on the LCD 203.

Each column of cards has a display window 204 showing the card currently held in the final dispense position and a lighted push button 205 for selecting that column. Purchased cards are fed to the customer through dispensing slots 206 for each column (shown more clearly in FIG. 2B).

As with the previous embodiment, the cash and cards are located in separately locked compartments; one for the product 207 and the other for the cash 208.

The card dispensing mechanism 209 removes the bottom card from one of the columns and delivers the card to the printer 210, which prints the winning or losing information on the sweepstakes tab portion of the card (shown more clearly in FIG. 2B-1). Unlike the previous embodiment depicted in FIGS. 1A and 1B, this alternate embodiment does not have a feeding mechanism that pushes the card into the final position. Instead, the printed card simply moves from the printer 210 through a feed slot 212 into the final dispense position 214. The next card 211 is then moved from the bottom of the stack to the printer 210.

The pricing is electronically selected and entered into the control board by means of a keypad 213 (shown in FIG. 2C). The price is also displayed on the lighted push button on the machine by inserting a label under the top cover of the push button cap.

The person loading the machine with cards makes certain that there is one card properly oriented and placed into the final dispense position 214 of each column. This card (and its winner information) is visible to the customer through the display window 204.

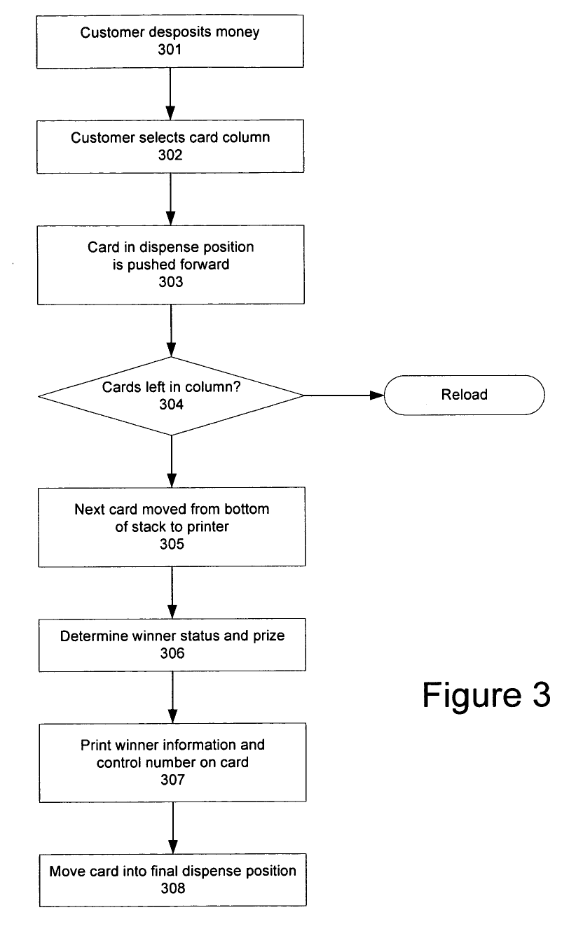

FIG. 3 is a flowchart illustrating the operations of the card dispensing machine. The customer deposits the proper amount of money into the machines, and the machine shows credit for the deposited money on a LCD display (step 301). The customer then selects one column and presses the light push button adjacent to that column (step 302).

After the customer has paid the requisite amount and selected the column, the card in the final dispense position is pushed forward and made available to the customer (step 303). The machine concurrently determines if there are any more cards remaining in the stack (step 304). If the stack is empty, the machine returns a reload indication by turning the push button light off adjacent to the corresponding column.

If there are more cards in the column, the machine removes the bottom card from the stack and transports to the printer (step 305). The control board randomly determines whether the card will be a sweepstakes winner and if so, what the sweepstakes cash prize will be (step 306). The printer then prints the winning information on the card along with a 12-digit control number on the visible side of the card (step 307). The newly printed card is then moved into the final dispense position (step 308). Customers will be able to see the card through the front of the machine and see if it is indeed a winner, but the customer will not have access to the card. This sequence is repeated until the column is empty.

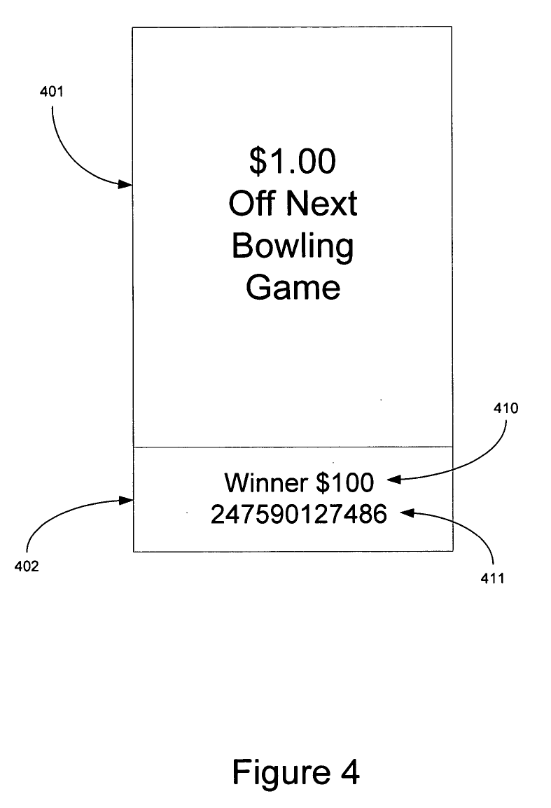

FIG. 4 shows an example of a coupon sweepstakes card in accordance with the present invention. The cards dispensed by the machine can take several forms. For example, the machine may dispense coupons at store locations, such as convenience stores, bowling allies, etc., to provide these retailers the opportunity to promote sales of their in-house, high profit products. In the present example, the card is a bowling alley coupon. Alternatively, the cards may be simple trading cards or similar card products. The coupons, trading cards, or other cards are promoted for sale by a sweepstakes feature.

The cards comprise two parts. One part is the coupon or trading card 401, and the other part, attached by perforation, is the sweepstakes tab 402. The coupons portion 401 contains all of the necessary discount information, as well as restrictions, expiration dates, etc. The sweepstakes portion 402 includes the winner/loser status of the card 410, the prize amount (if a winner), and a 12-digit control number 411. The sweepstakes portion may also include information about the odds of winning the different prize amounts with the game. The discount value of the coupon is in no way connected to the sweepstakes winner status.

In addition to the embodiment described above in which the sweepstakes card is physically attached to a coupon or trading card, the present invention may also be implemented using sweepstakes cards that are physically separate from the product being purchased. For example, the sweepstakes game may be associated with candy bars or other types of snack food or drinks. Traditionally, winner and prize information is contained inside the packaging material of the product (i.e. wrapper or bottle top). In such cases, the customer does not know if he or she has won a prize until after purchasing the product.

In the present invention, a sweepstakes card corresponding to an available item in the vending machine is displayed in a separate window. As each item is purchased and dispensed from the vending machine so is its corresponding sweepstakes card. As the next item in the queue is loaded into the empty display window, a corresponding sweepstakes card is printed and fed into its own display window.

The process of conducting the sweepstakes game and printing the cards is unchanged from the embodiments described above. This alternate embodiment has the advantage of making the sweepstake game applicable to products other than coupons and trading cards. This allows product manufacturers to conduct promotional sweepstakes games without the cost and hassle of changing their product packaging or administering the game themselves. In addition, the sweepstakes cards in this embodiment are extremely easy and inexpensive to produce because they are simply blank cards that are loaded into the vending machine.

As an alternative to having the game information printed on blank cards as they are drawn from the stack, all embodiments of the present invention may incorporate cards with all relevant game information pre-printed on them. The advantage of this alternate embodiment is a simpler dispensing machine that does not require a printer. For security purposes the pre-printed cards can be sealed in a plastic sleeve to protect the identity of the prize certificates. However, the potential disadvantages of this approach include increased production costs of the game cards (which could outweigh the cost savings of the simpler dispensing machines) and reduced security on the part of those loading the cards into the machines if the sleeve have to be removed before loading the cards (depending on the design of the machine).

Game cards are provided in shipping containers of a weight and size that are convenient for handling, e.g., 5,000 to 10,000 cards (or in the case of standalone sweepstakes cards, a number corresponding to the product capacity of the vending machine, e.g., number of soft drink cans or chip bags). An authorization code is also included in the shipping container. This code is entered into the machine to authorize the sweepstakes portion of the product. The authorization code can take several forms such as, e.g., pin number, a coupon swiped through the bill acceptor, a magnetic swipe card, or a computer disk. The shipping container also contains a 12-digit serial number for that batch.

The authorization code and serial number are entered when the first cards of a new batch are loaded into the machine. The authorization code allows the machine to dispense the entire batch of cards from the machine, with a small allowance for count errors. The authorization code prevents other card suppliers from providing cards for the machine, and the serial number reduces the chances of fraud in redeeming sweepstakes prizes.

The cards within a given batch are printed identically. The unique nature of the cards is established in the machine itself when the control number and winning status are printed on the cards as they are drawn from the bottom of the column. By allowing the cards to be identical, this feature makes the cards very economical to manufacture and print in batches. It also reduces the chances of any fraud that could take place between when the cards are mass printed and when they are loaded into the machine.

The control board knows the prize structure of the game by knowing the serial number that is included with each batch of cards. The sweepstakes prize structure for each batch contains a given number of winners of several different prize amounts. These winners are distributed over the population of the card batch until they are entirely used up within the batch (randomly finite). For example, the distribution of winners may be one in five. The distribution of winners may be spread over each individual machine or over the collective population of machines participating in the game.

The control board keeps track of the quantity of cards dispensed on a cumulative basis and compares it to the quantity of cards authorized. If the machine runs out of authorization, the machine will stop and display an error code that indicates the problem.

The printer prints the status on all of the cards in a batch, whether they are winners or losers. This eliminates the reuse of tickets by both the customer and the retail location. Reports of winners and losers according to product, batch, and date are provided through the control board. This information is available through a remote computer connection (i.e. modem), a printer, or the LCD on the machine. Other reports are available such as quantity of cards dispensed and cash taken in by date or time period. The machine also provides diagnostics for servicing and troubleshooting technical problems.

In an alternate embodiment of the present invention, the sweepstakes game is run by an offsite server rather than the local control board of the vending machine. This server operates the vending machine control board through a secure network connection. This alternate approach has the advantage of increasing security and reducing possible fraud since the rules, prize structure, and operation of the game are centrally controlled and monitored. In addition, storing the game in the server as opposed to the control boards of the individual vending machines makes updating the game considerably easier and more reliable, since only one update is needed for the entire network of participating vending machines.

Most state gambling laws require a “no purchase necessary” provision for such games. If a player wishes to obtain a prize certificate without making a purchase, the player may obtain a game card through the mail. In order to maintain the randomness of the game cards available by mail, a random plurality of prizes can be withheld from distribution via the card dispensing machines and reserved for mail distribution. These reserve mail cards may be covered with a security device so that the persons mailing the cards do not know the value of the cards in question, thus preventing game tampering.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A vending machine, comprising:
(a) a currency collector;
(b) at least one card holder that holds a plurality of game cards, wherein the cards are part of a sweepstakes game;
(c) an instruction set containing the rules of the sweepstakes game that determines whether a game card is a winner or loser as each game card is drawn from the card holder;
(d) a printer that prints whether a game card is a sweepstakes winner or loser as each game card is drawn from the card holder; and
(e) a card display window that holds the latest game card drawn from the card holder, wherein a customer can see whether the game card is a sweepstakes winner or loser before purchasing the card.

2. The vending machine according to claim 1, wherein the instruction set in part (c) is stored in a control board in the vending machine.

3. The vending machine according to claim 1, wherein the instruction set in part (c) is stored on a server that is accessed by the vending machine via a communications link.

4. The vending machine according to claim 1, wherein the game cards are attached to product coupons by perforation.

5. The vending machine according to claim 1, wherein the game cards are attached to trading cards by perforation.

6. The vending machine according to claim 1, wherein each game card is purchased in conjunction with an item sold by the vending machine.

7. The vending machine according to claim 1, wherein the printer prints a unique verification code on each game card as the cards are drawn from the card holder.

8. The vending machine according to claim 1, wherein the number of winners is distributed over a specified number of game cards in a randomly finite manner.

9. The vending machine according to claim 1, wherein after purchasing a game card, customers may obtain change in the form of a gift card for the value of the balance.

10. A vending machine, comprising:
(a) a currency collector;
(b) at least one card holder that holds a plurality of game cards, wherein the cards are part of a sweepstakes game; and
(c) a card display window that holds the latest game card drawn from the card holder, wherein a customer can see whether the game card is a sweepstakes winner or loser before purchasing the card.

11. The vending machine according to claim 10, wherein prize information is printed on the game cards by a printer in the vending machine as each game card is drawn from the card holder.

12. The vending machine according to claim 10, wherein prize information is pre-printed on the game cards before they are loaded into the vending machine.

13. The vending machine according to claim 12, wherein the game cards are sealed in a protective sleeve to prevent tampering.
